(19) United States
(12) Patent Application Publication
(10) Pub. No.: US 2011/0215888 A1
(43) Pub. Date: Sep. 8, 2011

(54) WIRELESS CONTROL OF MICROROBOTS

(75) Inventors: Jacob J. Abbott, Salt Lake City, UT (US); Arthur W. Mahoney, Salt Lake City, UT (US); Thomas W. R. Fountain, Salt Lake City, UT (US)

(73) Assignee: UNIVERSITY OF UTAH, Salt Lake City, UT (US)

(21) Appl. No.: 12/945,720

(22) Filed: Nov. 12, 2010

Related U.S. Application Data
(60) Provisional application No. 61/260,678, filed on Nov. 12, 2009.

(51) Int. Cl. H01F 7/00

(52) U.S. Cl. 335/229

(57) ABSTRACT

Wireless control of a microrobot can be performed using a magnetic field originating from a localized control magnet source relative to a body into which the microrobot is placed. Torque forces which contribute to rotation (and propulsion) of the microrobot can overcome magnetic forces which produce attraction or repulsion between the microrobot and the control magnet.

This application claims the benefit of U.S. Provisional Patent Application Ser. No. 61/260,678, entitled “Wireless Control of Microrobots” which was filed on Nov. 12, 2009, and which is herein incorporated by reference in its entirety for all purposes.

### FIELD

The present application relates to wireless control of microrobots. More particularly, the present application relates to control of microrobots using a magnetic field.

### BACKGROUND

Microrobots hold promise in a variety of fields, including medical applications. Microrobots can access locations that are currently difficult or impossible to reach. While a microrobot can be controlled through a tether, in some applications it is undesirable to include a tether. Accordingly, research is being conducted into microrobots which can be remotely controlled through a wireless link.

One example of a class of microrobots is helical microrobots. Helical microrobots include a screw-like element which can provide propulsion when rotated. Rotation of the screw-like element within a medium (e.g., fluid, tissue, and the like) causes propulsion of the microrobot. Rotation of the screw-like element can be effected by coupling a magnetic material to the screw-like element. By placing the microrobot into a slowly rotating magnetic field, the magnetic field produces torque onto the magnetic material of the microrobot, causing the screw-like element to rotate.

In addition to torque produced by the rotating magnetic field, magnetic forces can also be produced. To minimize magnetic force, while maximizing magnetic torque, a uniform magnetic field is generally used. To produce a uniform magnetic field, relatively large (compared to the size of the microrobot) magnetic coils are used. Between the magnetic coils, a uniform strength magnetic field can be produced. To provide for control of the magnetic field in three directions, three sets of coils (e.g., six coils total) are typically used. The magnetic coils must be sufficiently large so that the body into which the microrobot is going to be inserted can be placed inside the magnetic coils.

Adequate size coils can be provided for experiments in microscopic and small-scale laboratory controlled environments. Unfortunately, scaling up these systems for in vivo clinical use has proven difficult or impractical. For example, to completely enclose a human body requires very large coils, and relatively high magnetic field strengths.

### SUMMARY

In some embodiments of the invention, a method of controlling a microrobot is provided. The microrobot can have a magnetic element. The method can include inserting the microrobot into a body and disposing a control magnet adjacent to the body. A magnetic field produced by the control magnet can impinge upon the body. Another operation in the method can be rotating the magnetic field of the control magnet so that magnetic torque produced by interaction between the magnetic element and the control magnet causes rotation of the microrobot around an axis of the microrobot. The rotation of the microrobot can cause propulsion of the microrobot through the body. The method can also include adjusting a position of the control magnet relative to the microrobot so that magnetic torque produced by interaction between the magnetic element and the control magnet causes a redirection of the axis of the microrobot.

In some embodiments of the invention, a system for control of a microrobot is provided. The system can include a source means for generating a rotating magnetic field originated from a localized source relative to the body. Coupled to the source means can be a positioning means for controlling a position of the source means. The positioning means can be translatable in at least two degrees of freedom.

In some embodiments of the invention, a control unit for control of a microrobot within a body is provided. The control unit can include a control magnet coupled to a positioner. The positioner can be capable of moving in at least two degrees of freedom, and the control magnet can be capable of generating a rotating magnetic field.

### BRIEF DESCRIPTION OF THE DRAWINGS

Additional features and advantages of the invention will be apparent from the detailed description that follows, taken in conjunction with the accompanying drawings, that together illustrate, by way of example, features of the invention; and, wherein:

FIG. 1 is an illustration of a microrobot within a body being controlled by a control system in accordance with some embodiments of the present invention.

FIG. 2 is an illustration of an example of a control unit for controlling a microrobot within a body in accordance with some embodiments of the present invention.

FIG. 3 is an illustration of another example of a control unit for controlling a microrobot within a body in accordance with some embodiments of the present invention.

FIG. 4 is an illustration of a microrobot within a body being controlled by a control system in accordance with some alternate embodiments of the present invention.

FIG. 5 is a side view illustration of a microrobot being controlled by a control unit in both an axial control region and a radial control region in accordance with some embodiments of the present invention.

FIG. 6 is a perspective view of a microrobot being controlled by a control unit in a radial control region showing a 90 degree lead relationship in accordance with some embodiments of the present invention.

FIG. 7 is a time series showing the relative orientations of the control magnet in the control unit relative to the magnetic element in the microrobot in accordance with some embodiments of the present invention.

FIG. 8 is a graph showing break-away and step-out frequency as a function of axial distance between a microrobot and a control unit when performing axial control in accordance with some embodiments of the present invention.

FIG. 9 is a graph showing step-out frequency as a function of axial distance between a microrobot and a control unit for different radial distances when performing radial control in accordance with some embodiments of the present invention.

### DETAILED DESCRIPTION

Reference will now be made to the exemplary embodiments illustrated in the drawings, and specific language will be used herein to describe the same. These examples, including particular implementation details and parameters, are for non-limiting illustration only. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In describing the present invention, the following terminology will be used:

The singular forms “a,” “an,” and “the” include plural referents unless the context clearly dictates otherwise. Thus, for example, reference to an item includes reference to one or more of the items.

As used herein, the term “about” means quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art.

By the term “substantially” is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all the individual numerical values or sub-ranges encompassed within that range as if each numerical value and sub-range is explicitly recited. As an illustration, a numerical range of “about 1 to 5” should be interpreted to include not only the explicitly recited values of about 1 to 5, but also include individual values and sub-ranges within the indicated range. Thus, included in this numerical range are individual values such as 2, 3, and 4 and sub-ranges such as 1-3, 2-4, and 3-5, etc. This same principle applies to ranges reciting only one numerical value and should apply regardless of the breadth of the range or the characteristics being described.

As used herein, a plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items.

As used herein, the term “alternatively” refers to selection of one of two or more alternatives, and is not intended to limit the selection to only those listed alternatives unless the context clearly indicates otherwise.

As introduced above, prior systems using magnetic methods for propulsion of microrobots have used uniform magnetic fields. Slow rotation of the uniform magnetic field can produce a torque on the microrobot. This torque in turn causes rotation of the microrobot. Rotation of a helical member can cause propulsion of the microrobot through a fluid or other material.

It has been recognized by the present inventors that a magnetic control system that uses a single, localized magnetic source would be advantageous, as the use of large magnetic coils to surround the body can be avoided. Unfortunately, a single, localized magnetic source introduces magnetic field gradients, which produce forces (e.g., magnetic attraction and repulsion, referred to generally herein as “gradient forces”) on the microrobot. These gradient forces are generally in directions which do not contribute to rotation (and thus propulsion) of the microrobot. The present inventors have developed techniques to manage and minimize the effects of these gradient forces. In particular, a microrobot can be operated in a region where the magnetic field imposed by the control system is non-uniform (i.e., non-uniform magnitude, non-uniform direction, or both), yet magnetic forces are substantially minimized.

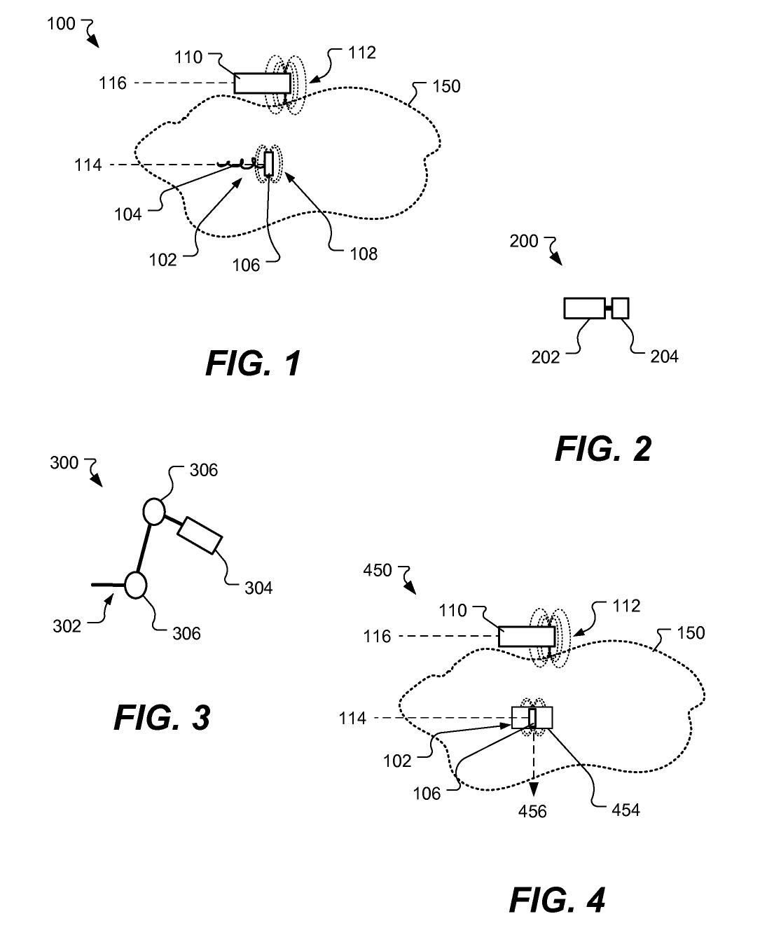

Turning to FIG. 1, a system for controlling a microrobot within a body is illustrated in accordance with some embodiments of the present invention. The system 100 can include a microrobot 102 that can be inserted into a body 150. The body 150 can be, for example, a living organism, such as a human being. The microrobot 102 can have a suitable size for being inserted into the body. For example, microrobots have dimensions up to few centimeters in size can be used, although the invention is not limited to any particular size microrobot. A variety of medical therapies can be provided using a microrobot. The microrobot can be inserted into the body through, for example, an orifice or a surgical incision. The microrobot can operate within a lumen, such as for example: blood vessel, spinal canal, intestine, etc. As another example, the microrobot can operate within a volume, such as for example: within an organ, within an area of tissue, etc. The microrobot can be used, for example, for targeted therapy (e.g., delivering drugs), material insertion (e.g., a stent), material removal (e.g., ablation), remote sensing, and the like. The microrobot can be tethered (e.g., towing a guide wire) or unthethered. Heating or cooling of the microrobot can be used to provide thermal therapy.

The microrobot can include a propulsion element 104 that is coupled to a magnetic element 106. The propulsion element can, for example, have a helical (e.g., spiral or screw-like) shape. As another example, the microrobot can include a body in which the magnetic element is disposed as described further below. Magnetic torque acting upon the magnetic element 106 can cause the magnetic element to rotate, in turn rotating the propulsion element 104, producing a force along the axis 114 of the microrobot. Thus, the microrobot 102 can (depending on the direction of rotation) be advanced in a forward or reverse direction through the body 150. The magnetic element 106 can be a permanent magnet or a soft-magnetic material. A soft-magnetic material is a material which can be magnetized by a magnetic field imposed on the material, but does not tend to remain magnetized when the magnetic field imposed thereon is removed. Thus, the magnetic element can generate a magnetic field 108 (e.g., autonomously in the case of a permanent magnet, or in response to an imposed field in the case of a soft magnetic material).

The system 100 can also include a control unit 110. The control unit can include a means for generating a rotatable magnetic field 112. The rotatable magnetic field can rotate about an axis 116. Because the rotatable magnetic field 112 originates from the control unit, it can therefore be from a localized source relative to the body. This is in contrast to conventional systems that use large distributed coils, and thus do not present a localized source. Because the magnetic field 112 originates from a localized source, the magnetic field will generally be nonuniform within the body 150, and more particularly, can have field gradients within the body, and in particular in the area in which the microrobot 102 operates. In other words, the magnetic field 112 can have gradients in the immediate vicinity of the microrobot 102.

Various ways of providing the rotatable magnetic field 112 can be used. For example, the control unit 110 can include a rotating permanent magnet. FIG. 2 illustrates an example of a control unit 200 which includes a motor 202 to which a permanent magnet 204 is mounted. The permanent magnet can, for example, be an axially or diametrically magnetized element. The motor 202 can provide for a controlled rate of rotation of the permanent magnet 204. More particularly, the motor 202 can provide for control of the rotational position and rotational velocity of the permanent magnet 204.

Various other ways of providing a rotatable magnetic field can be used as well. For example, in place of the permanent magnet 204, an electromagnet (not shown) can be used. In place of the motor, any suitable element capable of providing controlled rotary motion can be used. As yet another example, the rotating magnetic field can be generated entirely electronically using one or more electromagnets. Control of the direction of the magnetic field can be provided by electronically varying the current amount and direction within the one or more electromagnets.

Returning to the discussion of FIG. 1, the control unit 110 can include a positioning means for controlling a position of the source of the rotatable magnetic field. In particular, the positioning means can allow for control of the position and orientation of the magnetic field 112 relative to the body 150 (and relative to the microrobot 102) in one or more degrees of freedom.

For example, as shown in FIG. 3, a control unit 300 can include a positioner 302 coupled to a magnetic field source 304. The magnetic field source 304 can be like control unit 200. The positioner 302 can include one or more controllable joints 306 to allow the magnetic field source 304 to be moved in at least two degrees of freedom. For example, the positioner can be a robotic arm which can be controllable to allow positioning the magnetic field source 304 in a desired position relative to a body into which a microrobot is inserted. The positioner can provide for movement (translation) in one, two, or three directions. In addition, the positioner can provide for rotation in one, two, or three axis to allow the magnetic field source 304 to be placed in a desired orientation relative to a body.

As another example, the control unit 110 can be designed for handheld use in which case no positioner is necessary. For example, a control unit like 200 can be packaged into a small assembly which can be held by hand.

Returning to FIG. 1, use of the system 100 can be as follows. The microrobot 102 can be positioned into the body 150. For example, the microrobot can be inserted into a living organism through a surgical incision or into a body opening. The control unit 110 can be positioned adjacent to the body 150 so that the magnetic field 112 produced by the control unit impinges upon the body 150.

The magnetic field 112 can be rotated so that magnetic torque produced by interaction between the magnetic element 106 of the microrobot 102 and the magnetic field 112 causes the propulsion element 104 to rotate around an axis 114 of the microrobot. The rotation of a spiral or corkscrew shaped propulsion element 104 can cause propulsion of the microrobot 102. Depending on the direction of rotation of the magnetic field 112, the direction of rotation of the microrobot 102 is determined, from which propulsion in a forward or reverse direction along the axis 114 can be obtained.

Alternatively, the microrobot 102 need not include the propulsion element 104, and can be propelled by a rolling motion. For example, FIG. 4 illustrates a system 450 for controlling a microrobot 452 within a body in accordance with some embodiments of the present invention. The microrobot 452 can include a magnetic element 106. The microrobot can be caused to rotate around its axis 114 using a control unit 110 as described above. Friction between the sides 454 of the microrobot and material within the body 150 can cause the microrobot to roll in a direction 456 perpendicular to the axis 114.

For both modes of propulsion illustrated in FIG. 1 and FIG. 4, steering of the microrobot 102 can be provided by the control unit. Steering can be performed by adjusting the position of the control unit 110 relative to the microrobot 102. Alternatively, or in addition, steering can be performed by adjusting the orientation of the control unit 110 relative to the microrobot 102. In particular, adjustment of the position of the control unit 110 relative to the microrobot 102 can adjust magnetic torque produced by interaction between the magnetic element 106 and the magnetic field 112 to cause redirection of the axis 114 of the microrobot. Propulsion and steering can occur simultaneously as explained further below.

While the control unit 110 is shown in a radial position approximately perpendicular to the axis 114 of the microrobot 102, this is not essential. For example, the control unit 110 can alternatively be positioned in an axial position in line with the axis 114 of the microrobot 102.

The control unit 110 can also be positioned at other locations relative to the axis 114 of the microrobot, in which case the behavior deviates from that observed in the radial and axial positions, and the magnitude of the behavioral deviation is proportional to the locational deviation.

As mentioned above, field gradients due to the use of a localized source can produce magnetic force (attraction or repulsion) in addition to the rotational (propulsion) torque. The magnetic force can tend to push the microrobot 102 toward or away from the control 112 unit, depending on the relative directions of the magnetic field of the microrobot magnetic element 106 and the magnetic field 112 from the control unit 110. It has been observed, however, that forces produced by torque propulsion can overcome the magnetic force for a sufficiently high rate of rotation of the magnetic field 112. The optimum rate of rotation is a function of the field strengths, distances, mass of the microrobot, propulsion efficiency of the propulsion element, and various other factors. In general, during operation, the microrobot 102 rotates in synchronization with the rotating magnetic field 112. In particular, the microrobot 102 rotates at the same rate as the magnetic field 112, but with lag. More particularly, the control unit 110 can be operated so that the magnetic field 112 direction (i.e., field line orientation) in the vicinity of the magnetic element 106 is maintained approximately ninety degrees ahead of the magnetic axis of the magnetic element 106. Under such conditions, the magnetic torque (which produces turning motion of the microrobot 102) is generally at a maximum while the gradient forces (which produce attraction or repulsion between the microrobot and the control unit 110) are at a minimum.

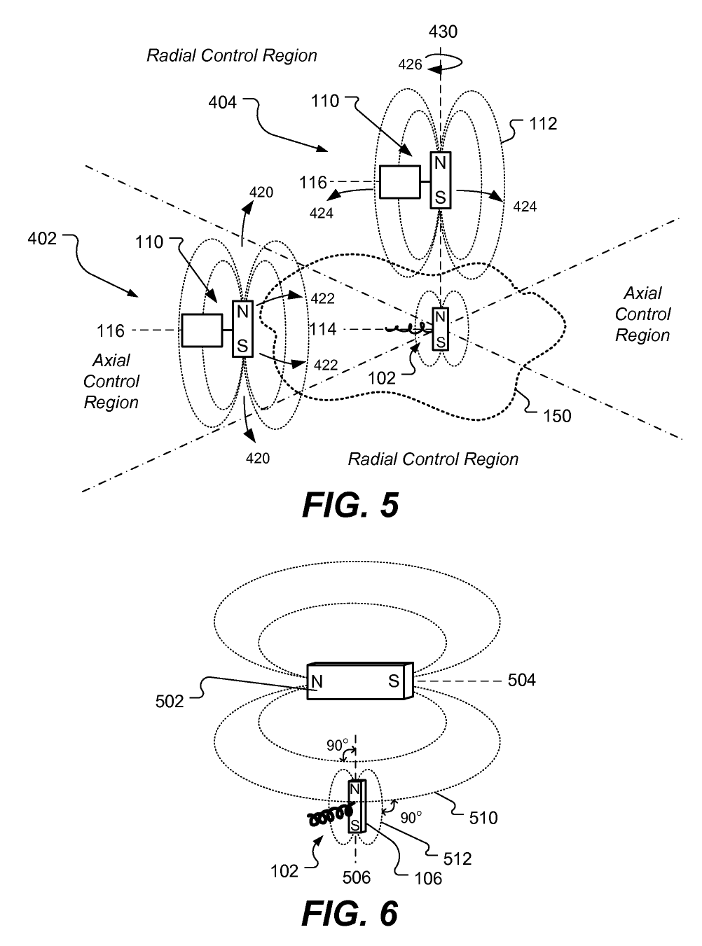

Turning to FIG. 5, the propulsion and steering will be described in further detail. The magnetic field 112 of the control element can result in a combination of magnetic force and magnetic torque on the magnetic element 106 of the microrobot 102. In general, magnetic torque is the result of the cross product of the applied magnetic field 112 (from the control unit 110) and the magnetic dipole of the magnetic element 106. Torque which is oriented about the principle axis 114 of the microrobot will therefore cause rotation of the microrobot, which in turn can cause propulsion of the microrobot. Torque oriented in other directions can therefore produce a force causing the axis 114 to pitch or yaw. Thus, depending on the relative orientation of the magnetic field 112 and the microrobot 102, a combination of rotational (propulsion) torque and pitch/yaw (steering) torque can be provided. Accordingly, the position and/or orientation of the control element 110 can be varied while the magnetic field 112 is being rotation to provide simultaneous propulsion and steering.

When the control unit 110 is positioned (position 402) so that the control unit is positioned in line with the axis 114 of the microrobot (and the rotation axis 116 of the magnetic field 112 is aligned with the axis 114 of the microrobot), the mode of operation is referred to as axial control. In axial control, movement of the control unit 110 away from axial alignment along the surface of a sphere centered on the microrobot (e.g., in directions 420, 422 up and down or in and out of the paper in FIG. 5) will tend to cause the microrobot to adjust its axis 114 to maintain alignment with the control unit. During axial steering, the axis 116 is perpendicular to the sphere on which the control unit 110 is moved. Under axial control, the microrobot 102 tends to rotate in the same direction as the direction of rotation of the magnetic field 112.

When the control unit 110 is positioned (position 404) so that the control unit is positioned in a location perpendicular to the axis 114 of the microrobot (and the rotation axis 116 of the magnetic field 112 is parallel to the axis 114 of the microrobot), the mode of operation is referred to as radial control. In radial control, movement of the control unit 110 along a circle in the plane defined by the microrobot 102 and the control unit can be used to provide one degree of freedom steering (e.g. direction 424 along a circle within the plane of the paper in FIG. 5). Rotation of the control unit 110 about a radial line 430 extending from the microrobot 102 to the control unit can be used to provide a second degree of freedom steering (e.g. rotation around an up/down axis in FIG. 5 in direction 426). Under radial control, the microrobot 102 tends to rotate in the opposite direction as the direction of rotation of the magnetic field 112.

Accordingly, in either radial or axial control modes, steering of the microrobot 102 can be provided by making small changes in the position and/or orientation of the control 110 unit, allowing the microrobot to servo to the desired steady state orientation. The control unit 110 can also be positioned in regions other than pure radial or pure axial control.

There can also be gradient forces (e.g., attraction or repulsion) on the microrobot 102 caused by the control unit 110. As discussed above, these forces are proportional to the gradient of the magnetic field 112 in the vicinity of the microrobot 102. Forces tending to push the microrobot 102 toward or away from the control unit 110 can be minimized when the orientation of the magnetic field 112 from the control unit 110 is such that the magnetic field in the vicinity of the microrobot 102 is in a direction perpendicular (ninety degrees) relative to the axis of the magnetic field of the microrobot. For example, FIG. 6 provides a perspective view in a radial control mode showing how a magnetic element 502 of a control unit 110 can be oriented with a 90 degree angle relative to the magnetic element 106 of the microrobot 102. In particular, the direction of the field lines 510 in the vicinity of the microrobot can be oriented so that they are perpendicular to the axis 506 (and hence field lines 512) of the microrobot's 102 magnetic element 106. For example, when performing axial control, maintaining a 90 degree lead corresponds to maintaining the axis 504 of the magnetic element 502 perpendicular to the axis of 506 of the magnetic element 106.

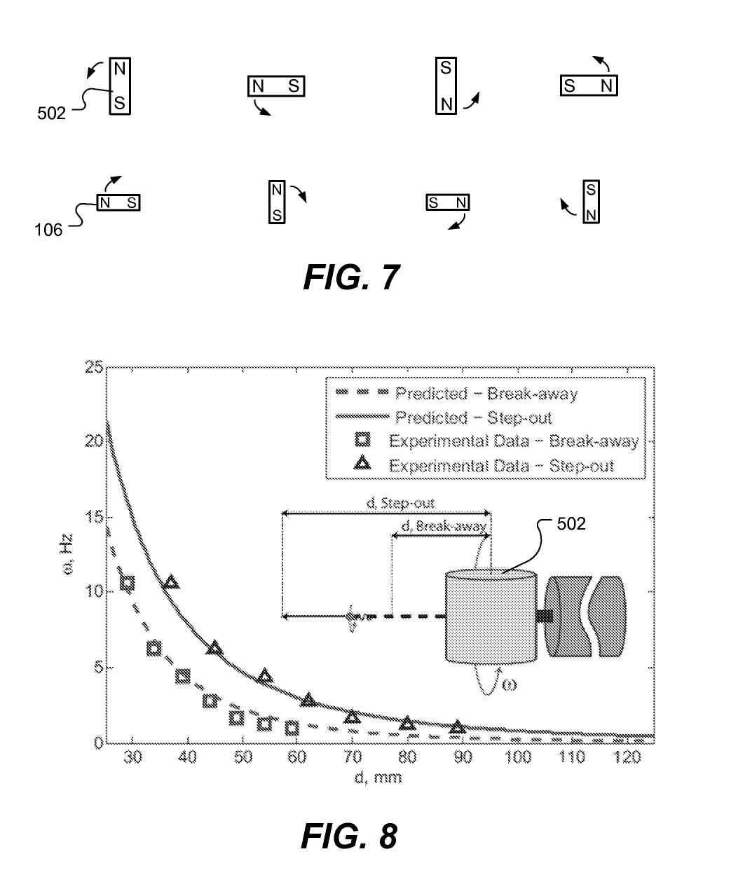

With the magnetic element 502 oriented so its magnetic field lines 510 in the vicinity of the microrobot 102 are perpendicular to the axis 506 of the magnetic element 106, not only is the gradient force minimized, but magnetic torque is also maximized. This can therefore help to maximize propulsion force while minimizing other force on the microrobot 102. Of course, since the magnetic torque is producing rotation of the microrobot, rotation of the magnetic element 502 of the control unit 110 can be performed to maintain the 90 degree relative phasing. Accordingly, the control unit 110 can be operated to maintain the 90 degree relative phasing. For example, FIG. 7 illustrates a time series showing the relative orientations of the magnetic element 502 of the control unit 110 relative to the orientation of the magnetic element 106 of the microrobot 102.

Returning to FIG. 1, depending on the direction of the rotation of the magnetic field 112 and the spiral orientation (e.g., left handed or right handed) of the propulsion element 104, the microrobot may move in a forward or backward direction. Up to a frequency referred to as step-out, as the rate of rotation of the magnetic field 112 is increased, the rate of rotation of the microrobot 102 will increase, and hence the velocity of the microrobot will increase. In general, the orientation of the magnetic element 106 will lag that of magnetic field 112 somewhat, with the lag angle increasing as a function of the rotation rate. Step-out is the frequency above which the microrobot 102 can no longer rotation in synchronization with the rotating magnetic field 112 (e.g., the lag angle begins to exceed 90 degrees and thus becomes unstable). At rotation frequencies above step-out, propulsion therefore drops off dramatically. Step-out occurs at the point where the magnetic torque is insufficient to overcome drag (friction) resisting rotation of the microrobot 102. Accordingly, maximum propulsion can be obtained by rotating the magnetic field 112 at frequencies close to, but less than, the step-out frequency. For example, the rotational frequency can be controlled to be between 30% and 75% of the step-out frequency, between 50% and 80% of the step-out frequency, between 75% and 95% of the step-out frequency, between 80% and 99% of the step-out frequency, or other desired ranges. In general, maintaining the rotation frequency close to, but slightly less than, the step-out frequency can provide maximum propulsion force. Beneficially, at rotation rates near the step-out frequency, the lag angle is close to 90 degrees, helping to minimize gradient forces as discussed above.

During axial control, an additional phenomenon referred to as break-away can be observed. In axial control, there can be an attractive magnetic force urging the microrobot 102 toward the control unit 110. Thus, when attempting to move the microrobot 102 away from the control unit 110, the propulsion force must be high enough to overcome this force. Accordingly, for rotation frequencies above the break-away frequency (yet less than the step-out frequency), net positive forward propulsion can be observed. Accordingly, the rotational frequency can be controlled to be greater than the break-away frequency and less than the step-out frequency.

During radial control, the gradient forces pushing the microrobot in directions parallel to the axis 114 tend to be zero when the microrobot 102 is aligned with the control unit 110, and hence there is no corresponding phenomenon similar to break-away. Accordingly, the rotation frequency can be between 0 and the step-out frequency. For example, the rotational frequency can be controlled to be less than 75% of the step-out frequency, less than 80% of the step-out frequency, less than 95% of the step-out frequency, less than 99% of the step out frequency, or other desired ranges.

The break-away and step-out frequency are each a function of the distance between the control unit 110 and the microrobot 102. For example, closer spacing results in higher magnetic torque, and hence higher step-out frequency. Closer spacing also, however, results in higher gradient forces, and hence higher break-away frequency. In general, as the distance is increased between the control unit 110 and the microrobot 102, the break-away and step-out frequencies are lower, but variation of the break-away and step-out frequencies with distance are smaller, thus allowing a potentially larger operational distance which can be covered for a fixed rotation frequency.

Increasing the size of the control unit 110 magnet (or equivalently, reducing the size of the microrobot 102 magnetic element 106) results in reduced gradients for a given magnetic torque. Accordingly, for a given rotation frequency, a larger range of distances can be covered. Scaling does not generally affect the shape of the step-out curve.

A particular, non-limiting example of an embodiment of the invention will now be described. In the example, the control unit was implemented using a rotating permanent magnet manipulator. A housing formed of Delrin material was mounted on a Maxon DC motor. The manipulator was capable of alternatively being fitted with either a cylindrical NdFeB magnet 25.4 mm in length and 25.4 mm in diameter, or a diametrically magnetized cylindrical NdFeB magnet of the same dimensions installed into the housing. The dipole strengths were found to be 10.2 A·m² and 12.6 A·m² for the magnets, respectively.

In the example, the microrobot was implemented using an approximately 4 mm diameter by 12 mm long spiral spring. Located at the one end was an NdFeB magnet of approximately 3.175 m length and 1.625 mm diameter. The magnetic dipole was measured to be approximately 7.2 mA·m².

FIG. 8 illustrates the break-away and step-out frequencies as a function of axial distance in the axial control region. In general, propulsion of the microrobot occurs at frequencies above the break-away curve and below the step-out curve.

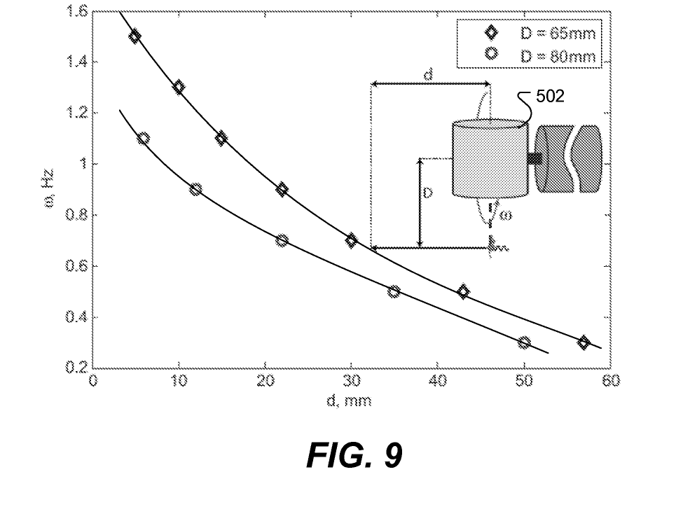

FIG. 9 illustrates the step-out frequency as a function of axial distance for two different radial distances in the radial control region. In general, propulsion of the microrobot occurs at frequencies below the step-out curve.

As will now be apparent, some embodiments of the invention can provide several advantages. Control of a microrobot can be performed using a rotating magnetic field which emanates from a localized magnetic source outside the body. This can help to avoid the need for large magnet systems which can surround the body. Moreover, since a non-uniform magnetic field can be used, difficulties with some body locations (e.g., the spinal column and other structures near the surface) where it is difficult to produce uniform magnetic fields can be obviated. While the resulting magnetic field imposed by the magnetic source on the microrobot is non-uniform, control of the rotation rate of the magnetic field can minimize attractive forces caused by magnetic field gradients while maximizing torque forces which help to produce rotation and propulsion of the microrobot. Because the magnetic source can be relatively small, it can be easily positioned and manipulated. It can be positioned near the surface of the body helping to provide higher magnetic torque. Steering can also be provided by relative positioning of the magnetic source relative to the microrobot. Both axial and radial control regions can be used, with differing properties obtained in each region. Simultaneous steering and propulsion can be provided. As a result, some embodiments of the invention can provide significantly greater maneuverability than previous microrobot systems.

While several illustrative examples and applications have been described, many other examples and applications of the presently disclosed techniques may prove useful. Accordingly, the above-referenced arrangements are illustrative of some applications for the principles of the present invention. It will be apparent to those of ordinary skill in the art that numerous modifications can be made without departing from the principles and concepts of the invention as set forth in the claims.

What is claimed is:

1. A method of controlling a microrobot, comprising:
inserting the microrobot into a body, wherein the microrobot comprises a magnetic element;
disposing a control magnet adjacent to the body so that a magnetic field produced by the control magnet impinges upon the body;
rotating the magnetic field of control magnet so that magnetic torque produced by interaction between the magnetic element and the control magnet causes rotation of the microrobot about an axis of the microrobot to propel the microrobot through the body; and
adjusting a position of the control magnet relative to the microrobot so that magnetic torque produced by interaction between the magnetic element and the control magnet causes a redirection of the axis of the microrobot.

2. The method of claim 1, wherein the rotating comprises maintaining the magnetic axis of the control magnet so that the direction of the magnetic field of the control magnet at the location of the magnetic element is substantially ninety degrees ahead of the magnetic axis of the magnetic element.

3. The method of claim 1, wherein the rotating and the adjusting are performed simultaneously so that the microrobot is simultaneously propelled and steered.

4. The method of claim 1, wherein the magnetic field has a non-uniform magnitude in the immediate vicinity of the microrobot.

5. The method of claim 1, wherein the magnetic field has a non-uniform direction in the immediate vicinity of the microrobot.

6. The method of claim 1, wherein the magnetic field originates from a localized area relative to the living organism.

7. The method of claim 1, wherein the body is a living organism.

8. The method of claim 7, wherein the living organism is a human being.

9. The method of claim 1, wherein the control magnet is positioned in line with the axis of the microrobot.

10. The method of claim 9, further comprising controlling the rate of rotation to maintain the rate of rotation greater than a break-away frequency and less than a step-out frequency.

11. The method of claim 1, wherein the control magnet is positioned perpendicular to the axis of the microrobot.

12. The method of claim 11, further comprising controlling the rate of rotation to maintain the rate of rotation less than a step-out frequency.

13. The method of claim 1, wherein the magnetic field strength produced by the control magnet within the body is less than about 0.1 Tesla.

14. A system for control of a microrobot within a body comprising:
a microrobot comprising a magnetic element; and
a control unit comprising a positioner and a control magnet coupled to the positioner, the positioner being capable of moving in at least two degrees of freedom, and the control magnet being capable of generating a rotating magnetic field.

15. The system of claim 14, wherein the control magnet comprises:
a rotator; and
a permanent magnet coupled to the rotator.

16. The system of claim 14, wherein the magnetic field has a non-uniform magnitude in the immediate vicinity of the microrobot.

17. The system of claim 14, wherein the magnetic field has a non-uniform direction in the immediate vicinity of the microrobot.

18. A system for control of a micro robot within a body comprising:
a source means for generating a rotating magnetic field originated from a localized source relative to the body, wherein the rotation is at a controlled rate;
a positioning means for controlling a position of the source means, wherein the positioning means is translatable in at least two degrees of freedom, and the source means is coupled to the positioning means.

19. The system of claim 18, wherein the positioning means is translatable in at least three degrees of freedom.

20. The system of claim 18, further comprising a means for adjusting the positioning means to simultaneously propel and steer a microrobot comprising a magnetic element.
